(19) United States
(12) Patent Application Publication
(10) Pub. No.: US 2006/0231566 A1
(43) Pub. Date: Oct. 19, 2006

(54) Apparatus and method for dispensing products

(76) Inventor: Abe Indig, Brooklyn, NY (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/108,044

(22) Filed: Apr. 14, 2005

(51) Int. Cl. G07F 11/16

(52) U.S. Cl. 221/266

(57) ABSTRACT

The apparatus includes a housing for receiving a plurality of products, and a rod pivotally coupled to the housing. The rod includes at least one opening defined therein for receiving at least one of the products. The apparatus further includes an actuator coupled to the rod and operable to pivot the rod from a receiving position, wherein the product is positioned within the opening, to at least one dispensing position, wherein the product is dispensed from the opening.

### BACKGROUND OF THE INVENTION

1. Field of the Invention

The present invention is related to the field of product dispensers, and more particularly, to a refillable product dispenser operable to dispense one or more products.

2. Description of Related Art.

Dispensers are frequently used for vending individual products in a variety of settings. For example, dispensers may be employed at check-out counters or positioned on store shelves or walls that are easily accessible to consumers or store clerks. Dispensers may be used to dispense cylindrical objects, such as chapstick or cosmetics, that are gravitationally fed to an opening where consumers may see the product displayed and access the product if desired. Using gravitation to advance products allows the newer products to be fed from the top or rear of the dispenser and sequentially fed towards the bottom or front so that the older products are dispensed first.

An example of a gravitational feed dispenser is disclosed in U.S. Pat. No. 5,294,020 to Kunz. In particular, Kunz discloses a dispensing mechanism that includes a reservoir for holding a plurality of cylindrical products. The reservoir communicates with a downwardly and forwardly extending chute that ends in a forward display position of a base. When the reservoir is loaded with cylindrical objects, the chute and display position are filled and upon removal of a cylindrical object, cylindrical objects descend under the influence of gravity from the reservoir to the chute and from the chute to the display position. When a cylindrical object is removed, the remaining cylindrical objects descend under the influence of gravity from the reservoir forwardly to the chute and from the chute forwardly to the display position.

The dispensing mechanism of Kunz, including the reservoir and chute, provide a technique for gravitationally dispensing various cylindrical products. Despite these improvements, additional innovations in dispensing products to promote effective and easier displaying and dispensing of products are desired.

It would therefore be advantageous to provide a dispensing apparatus that effectively dispenses various types of products. In addition, it would be advantageous to provide a dispensing apparatus that is compact and easy to use. It would also be desirable to provide a dispensing apparatus that is relatively inexpensive and easy to manufacture.

### BRIEF SUMMARY OF THE INVENTION

The present invention addresses the above needs and achieves other advantages by providing a dispensing apparatus that is capable of dispensing various products. The dispensing apparatus generally includes a housing that is capable of receiving any number of products and directing the products to an opening defined in a rod. An actuator is capable of manually or automatically dispensing one or more products from the rod. As such, a consumer or store clerk may utilize the actuator to dispense one or more products when desired.

In one embodiment, an apparatus for dispensing products is provided. For instance, the products could be chapstick, lipstick, lip gloss, lip balm, magic markers, glue sticks, batteries, laser pointers, candy holders, gum, pens, pencils, or vitamin packs. The apparatus includes a housing for receiving a plurality of products, and a rod pivotally coupled to the housing. The rod includes at least one opening defined therein for receiving at least one of the products. The apparatus further includes an actuator coupled to the rod and operable to pivot the rod from a receiving position, wherein the product is positioned within the opening, to at least one dispensing position, wherein the product is dispensed from the opening. The actuator could be manually or automatically operated to dispense one or more products.

In various aspects of the apparatus, the housing includes a tapered chute for funneling the products into the opening in the rod. The housing could include at least one angular divider arranged in the housing, wherein the chute and angular divider are capable of sorting and advancing each product prior to the product entering the opening in the rod. The housing could also include a dispensing tray, wherein a ramp extending proximate to the rod is capable of directing each product from the dispensing position to the dispensing tray.

Moreover, in additional variations, the rod extends horizontally and laterally within the housing. The rod may include a pair of openings each capable of receiving a respective product and carrying the product between a receiving position and a dispensing position. The angle between the receiving position and the dispensing position could be approximately 90 degrees.

In one embodiment, the actuator includes a linkage mechanism having a longitudinal arm coupled to a spring and a bar. The rod is preferably coupled to the bar, and the longitudinal arm is operable to cooperatively rotate the bar and rod between the receiving position and the dispensing position. The longitudinal arm may be oriented vertically, and the spring may extend coaxially along a portion of the rod. The longitudinal arm could be operable to compress the spring during cooperative rotation of the bar and rod from the receiving position to the dispensing position, and the spring could be operable to bias the longitudinal arm causing rotation of the bar and rod from the dispensing position to the receiving position.

In another embodiment, the actuator comprises a wheel mechanism coupled to the rod and operable to rotate the rod between the receiving position and the dispensing position. The rod may be capable of receiving a pair of products, and each product may be dispensed at respective first and second dispensing positions. The angle between the receiving position and a first dispensing position could be approximately 90 degrees, and the angle between the receiving position and the second dispensing position could be approximately 135 degrees.

Another aspect of the present invention also provides a method for assembling an apparatus for dispensing products. The method includes providing an apparatus that includes a housing for receiving a plurality of products, and a rod pivotally coupled to the housing. The rod includes at least one opening defined therein for receiving at least one of the products. The method also includes connecting the rod to an actuator such that the actuator is configured to pivot the rod from a receiving position, wherein the product is carried within the opening, to at least one dispensing position, wherein the product is dispensed from the opening.

In various aspects of the method, the method includes connecting the rod to the actuator such that the actuator is capable of pivoting the rod approximately 90 to 135 degrees between the receiving position and the at least one dispensing position. The method may include filling the housing with products such that one or more products are gravitationally directed to a respective opening in the rod in the receiving position. In addition, the method may include refilling the housing with products when the products have been reduced to a predetermined level.

The present invention provides several advantages. For example, the apparatus is adaptable for use with a variety of products. As such, the apparatus is not limited to a particular product such that various products may be utilized using the same dispensing apparatus. In addition, the apparatus is compact, which is advantageous where a limited amount of space is available, such as along check-out aisles or self-service areas. Because of the configuration and vertical orientation of the housing, the housing is capable of accommodating a greater amount of products than typical product dispensers. The combination of the actuator and configuration of the housing decreases the probability of jamming or misalignment of the products. Moreover, the self-service nature of the apparatus allows a user or vendor to dispense products when desired, and the housing provides increased sanitary and protection from external elements than typical dispensers. Providing a dispensing apparatus that is manufactured from a clear material enables consumers to readily identify the product, while store clerks may readily determine when the apparatus requires refilling. The outer surface of the dispensing apparatus is also conducive to various advertisements that may be displayed on the apparatus.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a side view of a dispensing apparatus, according to a first embodiment of the present invention;

FIG. 2 is a front view of the dispensing apparatus shown in FIG. 1;

FIG. 3 is an enlarged top view of an actuator of the dispensing apparatus shown in FIG. 1;

FIG. 4a is a side view of the dispensing apparatus of FIG. 1 showing a product positioned in a receiving position within a rod;

FIG. 4b is a side view of the rod shown in FIG. 4a in a first dispensing position;

FIG. 4c is a side view of the rod shown in FIG. 4a in a second dispensing position;

FIG. 5 is side view of a dispensing apparatus according to another embodiment of the present invention;

FIG. 6 is a front view of the dispensing apparatus shown in FIG. 5;

FIG. 7 is an enlarged view of an actuator of the dispensing apparatus shown in FIG. 5;

FIG. 8 is another enlarged view of the actuator of the dispensing apparatus shown in FIG. 5

FIG. 9a is a side view of the dispensing apparatus of FIG. 5 showing a product positioned in a receiving position within a rod;

FIG. 9b is a side view of the rod shown in FIG. 9a in a dispensing position; and

FIG. 9c is a side view of the product dispensed from the dispensing position shown in FIG. 9b.

### DETAILED DESCRIPTION OF THE INVENTION

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

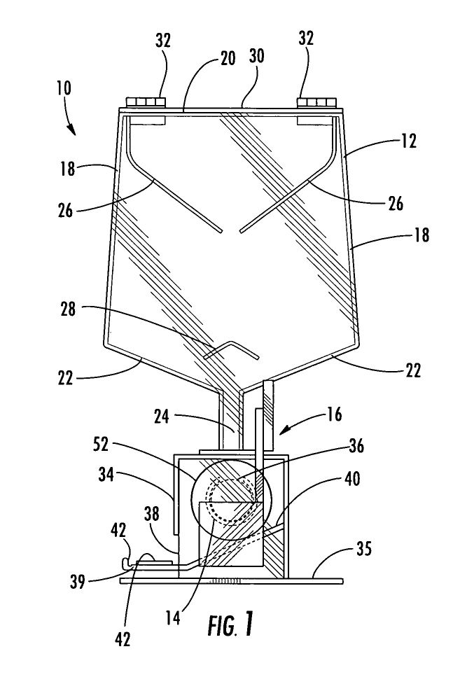

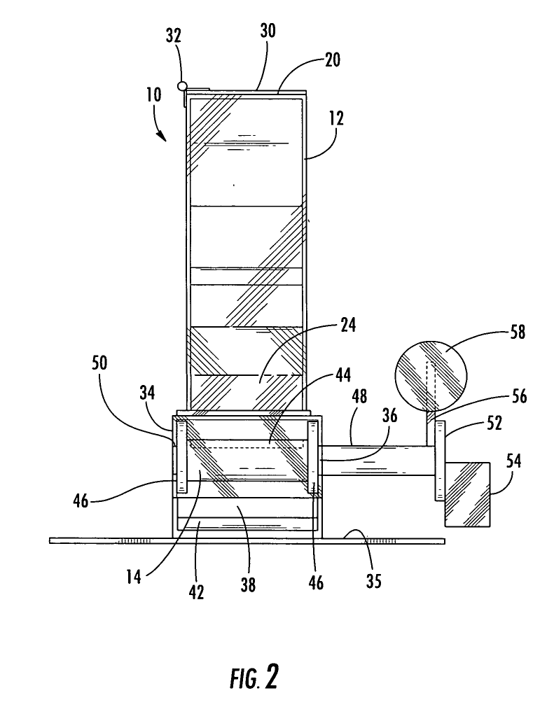

Referring to FIGS. 1 and 2, a dispensing apparatus 10 according to a first embodiment of the present invention is shown. The dispensing apparatus 10 generally includes a housing 12, a rod 14, and an actuator 16. As products are placed in the housing 12, the products are directed to the rod 14 where the actuator dispenses the product from the rod. The actuator 16, according to one embodiment, operates as a wheel mechanism to pivot the rod 14 and dispense the products. Thus, the dispensing apparatus 10 is useful for point-of-sale applications, such as along check-out aisles or self-service areas in stores or other locations where the products are sold. However, the dispensing apparatus 10 could also be utilized in non-retail situations, such as for personal or recreational use. Examples of potential products that may be employed with the dispensing apparatus 10 of the present invention include chapstick, lipstick, lip gloss, lip balm, magic markers, glue sticks, batteries, laser pointers, candy holders, gum, pens, pencils, and vitamin packs.

As shown in FIG. 1, the housing 12 includes a pair of lateral edges 18 that extend between a top edge 20 and a pair of angled edges 22. The pair of lateral edges 18 are slightly tapered between the top edge 20 and the angled edges 22, although the lateral edges could extend generally vertical. The angled edges 22 extend at about 45 degrees to a vertically extending chute 24 that is tapered to allow a single row of products to travel through the chute and to the rod 14. The housing 12 also includes a lid 30 positioned adjacent to the top edge 20 of the housing. The lid 30 is attached to a pair of hinges 32 that facilitate opening and closing of the lid. As such, the lid 30 may be readily opened so that the housing 12 may be filled and refilled with products.

The housing 12 also includes a pair of upper angular dividers 26 and a lower angular divider 28. Each of the upper angular dividers 26 includes a portion that extends vertically from the top edge 20 to an angled portion that extends downwardly at approximately a 45-degree angle within the housing 12. Each of the pair of upper angular dividers is positioned within the housing 12 to define a horizontal opening such that a single product is capable of traveling therethrough. Moreover, the lower angular divider 28 is positioned proximate to the angled edges 22 such that the products are directed on each side of the lower angular divider at approximately a 30-degree angle (from horizontal) to each of the angled edges and then to the chute 24. The upper 26 and lower 28 angular dividers are provided to not only direct each of the products within the housing 12, but also to reduce the risk of jamming in the chute 24.

The angular dividers 26 and 28 of the present invention should not be limited to that shown in FIG. 1, as there may be any number and configuration of angular dividers in additional variations of the present invention. For instance, there could be a single angular divider 26 positioned proximate to the top edge 20 of the housing 12 and additional angular dividers disposed within the housing at various locations and configurations to direct the products to the chute 24. There may even be instances where the angular dividers 26 are not desired, such that the angular dividers are optional.

The chute 24 attaches to a top edge of an actuator housing 34, while the actuator housing is attached to a base 35. The base 35 generally supports the housing 12 and actuator housing 34 and is of sufficient cross-sectional area to support the housing and prevent the housing from tipping. The actuator housing 34 includes an opening that permits products to travel from the chute 24 and into the rod 14. In addition, the actuator housing 34 includes a pair of openings 36 positioned on opposite sides of the actuator housing that allow the actuator 16 to extend through, and pivot within, the openings. The actuator housing 34 also includes a dispensing opening 38 where products may exit the actuator housing once dispensed from the rod 14 by the actuator 16. To direct the products from the rod 14 and to the dispensing opening 38, a ramp 40 is disposed within the actuator housing 34 and extends from a back edge of the actuator housing at an approximately 45-degree angle to a generally horizontal dispensing tray 39 located outside of the actuator housing. Raised edges 42 are arranged about the dispensing tray 39 to prevent the products from rolling out of the dispensing apparatus 10.

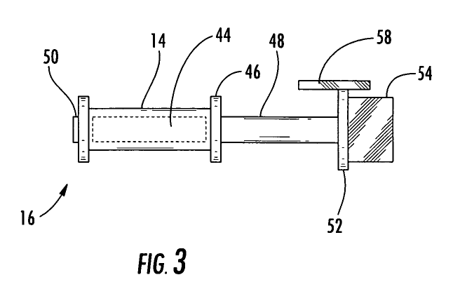

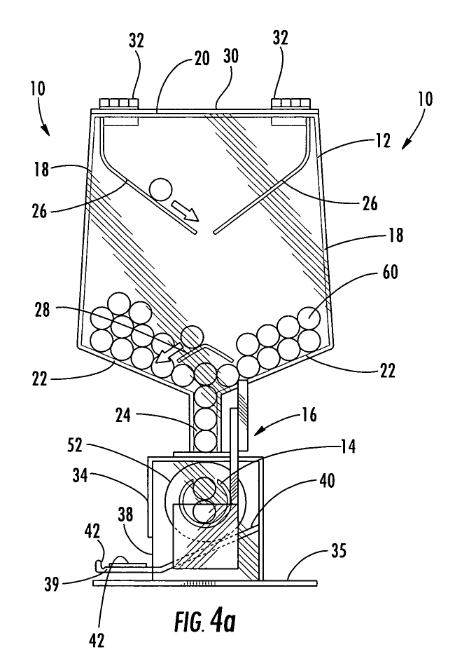

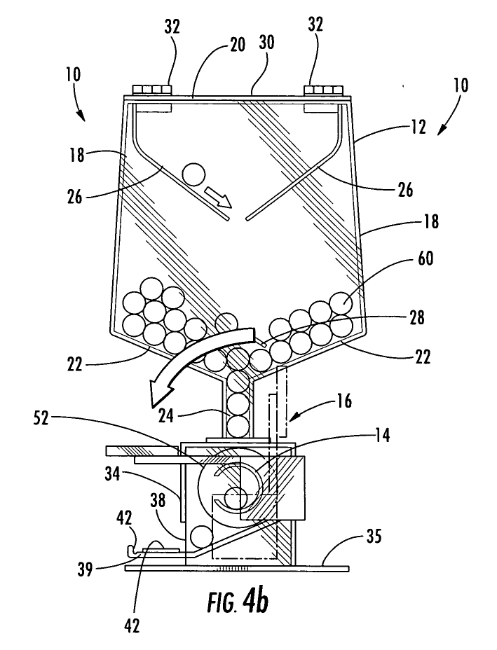

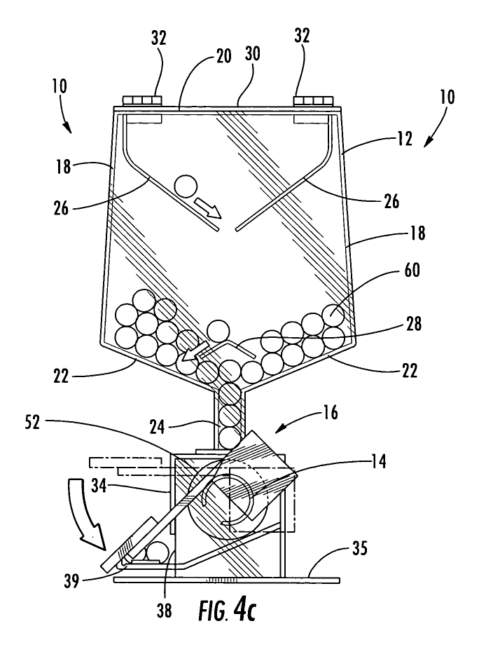

The actuator 16 accepts products traveling from the chute 24 and pivots within the actuator housing 34 to dispense the products from the rod 14. FIG. 3 demonstrates that the rod 14 is generally cylindrical and includes a rod opening 44 for receiving products. The rod 14 is oriented generally horizontally within the housing 12, and the rod opening 44 is defined along the length of the rod. Thus, the chute 24 and rod opening 44 align when the rod 14 is in a receiving position so that products may travel through the chute and into the rod opening. As shown in FIG. 4a, the width of the rod opening 44 is sufficient to receive a product, while the diameter of the rod 14 is configured to receive two products. However, it is understood that the rod 14 may receive any number of products, including a single product in variations of the present invention.

In addition, although the rod 14 shown in FIG. 4a includes a single rod opening 44, it is understood that the rod could have any number of openings in additional embodiments of the present invention. For example, the rod 14 could include a pair of rod openings 44 to receive respective products from the chute 24. In particular, the rod 14 could include a rod opening 44 that aligns with the chute 24 in a receiving position, as well as an additional rod opening that is capable of receiving an additional product as the rod is rotated. For instance, the second rod opening could be defined in the rod 14 at a location where an additional product enters through the second rod opening when the rod has been pivoted approximately 90 degrees, i.e., the second rod opening is located approximately 90 degrees from the first rod opening. As the rod 14 is pivoted further, the additional product may then be dispensed from the second rod opening, or the additional product could be dispensed when the rod is pivoted back to the initial receiving position. In another aspect of the present invention, the rod 14 could include a rod opening 44 at about 0 degrees, as shown in FIG. 4a, and a second rod opening at approximately 180 degrees. A divider could be provided within the rod 14 and between the rod openings 44 so that, as products enter respective rod openings, the divider prevents the products from entering a rod opening and falling out of the rod through an opposed rod opening.

Alternatively, the housing 12 could include a pair of chutes 24 that extend to respective rod openings 44. Thus, the housing 12 could be divided into separate sections, such as for separate products, and include a separate chute 24 for each section of the housing so that products from each chute are directed to a respective opening 44 in the rod 14. In this regard, the rod 14 could be appropriately sized and configured to receive at least two products through respective openings while in a receiving position.

The actuator 16 includes a pair of stops 46 that attach to respective ends of the rod 14. The stops 46 not only restrain the rod 14 laterally within the actuator housing 34 but also rotationally when pivoted. In particular, the stops 46 prevent the rod 14 from sliding horizontally beyond a predetermined distance within the actuator housing 34. Also, when the actuator 16 pivots the rod 14, the stops 46 are configured to prevent the rod from rotating beyond a predetermined angle. For instance, the stops 46 could be generally circular and positioned proximate to the top edge of the actuator housing 34. A portion of the stops 46 could be manufactured to include a smaller diameter portion (such as ¼ of the circumference of the stops) such that rotation of the stops is only permitted in one direction, while rotation in the opposite direction causes the larger diameter portion of the stops to contact the top edge of the actuator housing and prevent rotation.

It is understood that other techniques could be employed to allow rotation of the stop 46 in only one direction, such as a ratchet mechanism or a raised portion attached to the outer circumference of the stop. However, it is understood that the rod 14 and stops 46 could be freely rotatable in various aspects of the invention. For instance, the lever 56 and handle 58 (explained below) could be of sufficient length such that rotating the rod 14 a predetermined angle causes the lever and handle to contact a surface or base 35 to prevent further rotation.

FIG. 3 illustrates that the actuator 16 also includes a pair of extension rods 48, 50 that attach to respective stops 46. One of the extension rods 50 extends just enough to engage an opening 36 of the actuator housing 34. The second longer extension rod 48 extends through an opposite opening 36 in the actuator housing 34 and attaches to a stop 46. The extension rod 48 is attached to a disc 52, while the disc 52 is attached to a counterweight 54, lever 56, and handle 58. Thus, rotating the lever 56 and handle 58 causes the extension rod 48, stops 46, and rod 14 to also cooperatively rotate within the actuator housing 34. The counterweight 54 facilitates counter rotation when the rotating force is removed from the handle 58 and lever 56.

Exemplary dimensions are given for the dispensing apparatus 10 according to one embodiment of the present invention. For example, the distance between the lateral edges 18 is about 8 inches at the top edge 20 and about 8-½ inches adjacent to the angled edges 22. The angled edges 22 are about 4-½ inches in length between the lateral edges 18 and the chute 24, while the depth of a lateral edge 18 is about 3 inches. The chute 24 is about 2 inches in length between the angled edges 22 and the top edge of the actuator housing 34. The rod 14 is about 3 to 3-½ inches in length and about ¾ to 1 inch in diameter. It is understood that although specific dimensions have been given herein for various features of the dispensing apparatus 10, no feature should be limited to any specific dimension or orientation, as there could be variations in size and configuration of the features to accommodate different products or applications.

The dispensing apparatus 10 is preferably manufactured from a transparent Lucite® material. Thus, the material is generally lightweight and easily customized for a particular product or application. Other examples of suitable materials include Lexan®, Plexiglas®, or other plastic or composite materials. Each of the components of the dispensing apparatus 10 may be assembled with a suitable fastening technique, such as adhesive, fasteners, and the like. In addition, the material could be various thicknesses, such as ⅛ of an inch.

FIGS. 4a-c illustrate the progressive steps employed to pivot the rod 14 between a receiving position, where one or more products 60 are positioned within the rod, and one or more dispensing positions, where the product may be dispensed from rod. As used herein, the receiving position corresponds to a position of the rod 14 where one or more products may enter the rod opening 44. Similarly, the dispensing position corresponds to a position where one or more products may exit the rod opening 44. While the actuator 16 pivots the rod 14 between the receiving and dispensing positions, the one or more products are carried within the rod opening 44. FIG. 4a shows a plurality of products 60 positioned within the housing 12. Gravitation causes the products to proceed downwardly, while the configuration of the housing 12 and angular dividers 26 and 28 directs the products 60 in various directions to spread the products out and to help prevent jamming. As the products 60 are directed to the chute 24, two products are disposed within the rod 14. A user would then urge the handle 56 counterclockwise in the embodiment shown in FIG. 4a to pivot the rod 14 and cause a first product to exit the rod opening 44 in a first dispensing position, as shown in FIG. 4b. Once the product 60 exits the rod opening 44, the product travels down the ramp 40 until the product contacts the raised edge 42 in the dispensing tray 39. As the user further pivots the handle 56, the second product exits the rod opening 44 in a second dispensing position, as illustrated in FIG. 4c. The rod 14 pivots about 90 degrees to the first dispensing position and about 135 degrees to the second dispensing position, although various degrees of rotation may be employed with the present invention to dispense the products 60. The counterweight 48 causes the rod 14 to rotate back to the receiving position such that two more products 60 advance through the chute 24 and into the rod opening 44.

Although the steps involved in operating the dispensing apparatus 10 associated with FIGS. 4a-c were described as being operated manually, it is understood that the apparatus could be automated. For example, the actuator 16 could be coupled to a gear that is motorized to pivot the rod 14 between the receiving and dispensing positions. The motor could be activated with a push of a button. Moreover, the dispensing apparatus 10 may employ various lights and sounds for advertising or appeal. For instance, the dispensing apparatus 10 could be equipped with a speaker that is activated when the actuator 16 is actuated to transmit a message or sound. In addition, lights could be activated to display visual effects when the actuator 16 is actuated.

Furthermore, the dispensing apparatus 10 provides space for accommodating various advertisements. For instance, advertisements (e.g., “buy one, get one free” or “pay for one and drop one free”) may be placed directly on the dispensing apparatus 10. The advertisements could be placed on any visible location on the dispensing apparatus 10.

The dispensing apparatus 10 is also refillable. Thus, when the level of products reaches a predetermined level, additional products may be placed in the housing 12. In one example of refilling the dispensing apparatus 10, the products are packed in a box, where the bottom two flaps of the box form a triangular funnel. When the funnel is opened by removing tape, the flaps open allowing the products to easily roll into the housing 12.

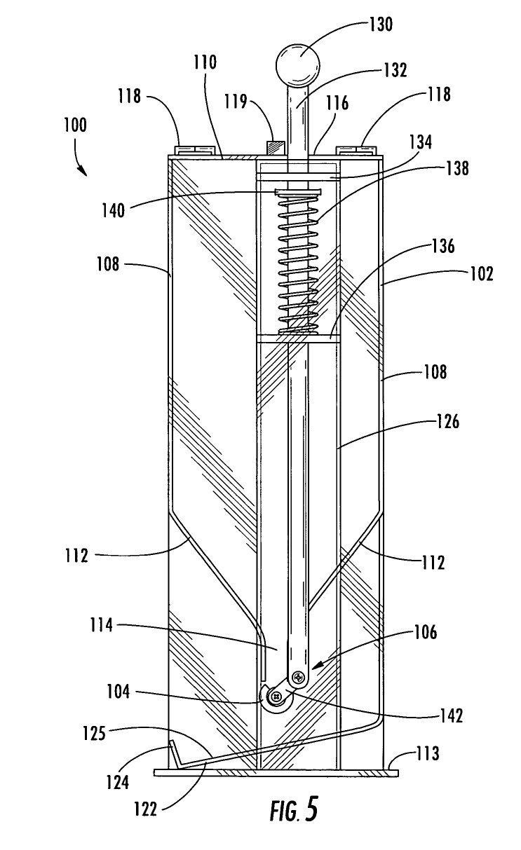

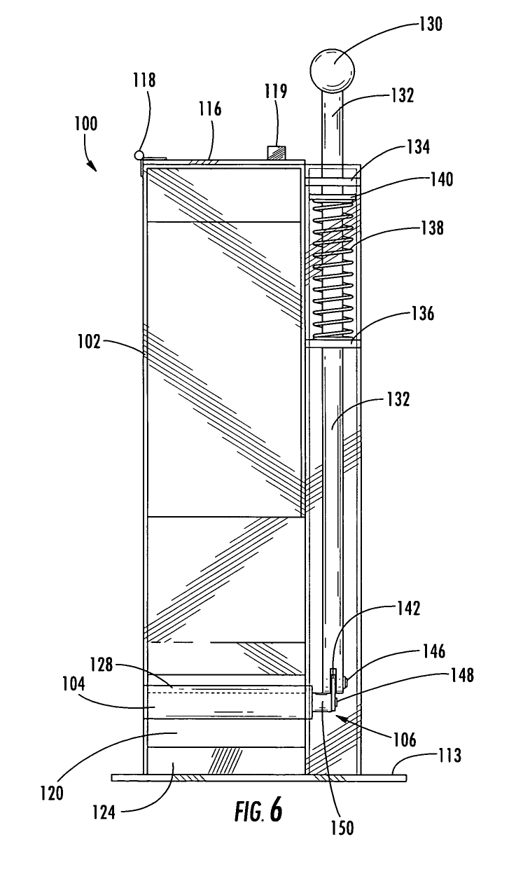

FIGS. 5 and 6 illustrate a dispensing apparatus 100 according to a second embodiment of the present invention. The dispensing apparatus includes a housing 102 and an actuator 106 pivotally coupled to a rod 104. The rod 104 receives a product that is gravitationally fed through the housing 102, and the actuator 106 is actuated to dispense a product from the rod. According to one embodiment, the actuator 106 includes a linkage mechanism that is capable of pivoting the rod 104 from a receiving position to a dispensing position, as will be explained in greater detail below.

The housing 102 shown in FIG. 5 includes a pair of generally vertical lateral edges 108 extending downwards from a top edge 110 to a base 113. The base 113 supports the housing in an upright position. A pair of angled edges 112 extends at about a 30-degree angle (from vertical) from the lateral edges 108 to a chute 114. Thus, the chute 114 extends generally vertically and is positioned at a distal end of the angled edges 112. The chute 114 is of a width that may receive a single row of products and direct the products to the rod 104. Moreover, the housing 102 includes a lid 116 that is attached to the top edge 110 of the housing by a pair of hinges 118. A lid handle 119 is provided that allows a user to readily open and close the lid 116.

Referring to FIG. 6, the housing 102 includes a dispensing opening 120, where products dispensed from the rod 104 with the actuator 106 travel down a ramp 122 through the dispensing opening and contact a raised edge 124 of a dispensing tray 125. As such, the ramp 122 directs products exiting the rod 104 to the dispensing tray 125, while the raised edge 124 stops the products so that the products may be accessed by a user and do not roll freely out of the dispensing tray.

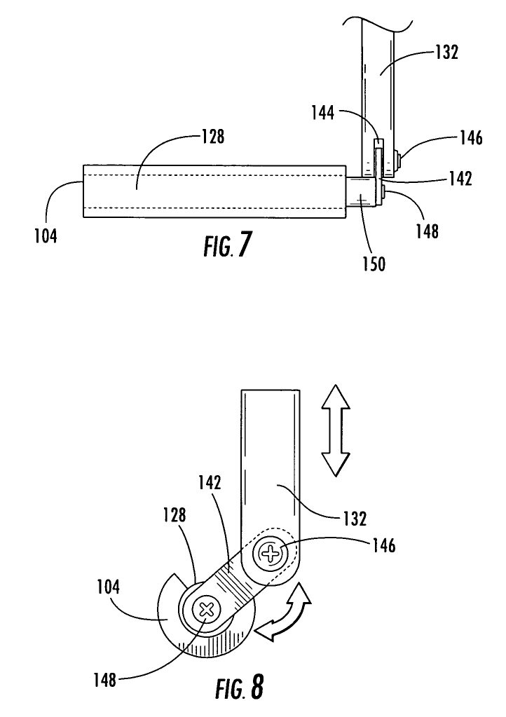

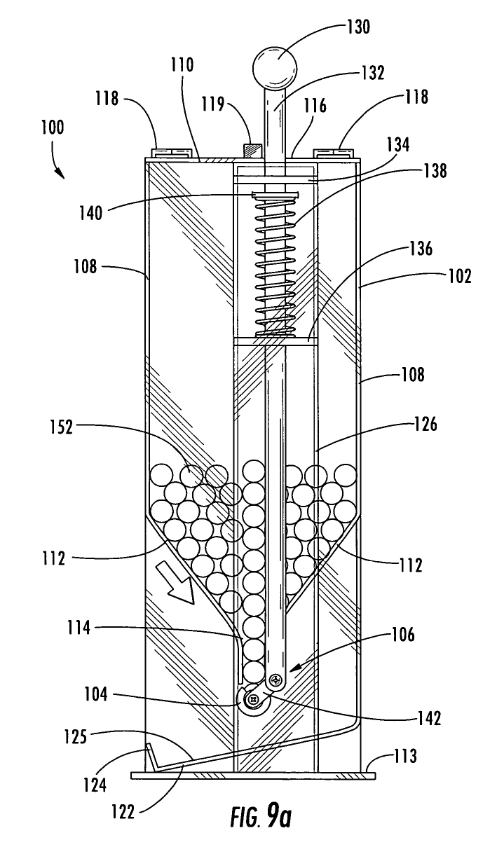

As shown in FIGS. 7 and 8, the rod 104 includes a rod opening 128 for receiving products traveling from the chute 114. Thus, the width and length of the rod opening 128 defined in the rod 104, as well as the diameter of the rod is sufficient to receive a product in a receiving position and transfer the product to the dispensing position when the actuator 106 is actuated. The rod 104 is oriented generally horizontally and laterally within the housing 102, while the rod opening 128 is positioned proximate to the chute 114 in a receiving position so that products traveling through the chute may enter the rod opening.

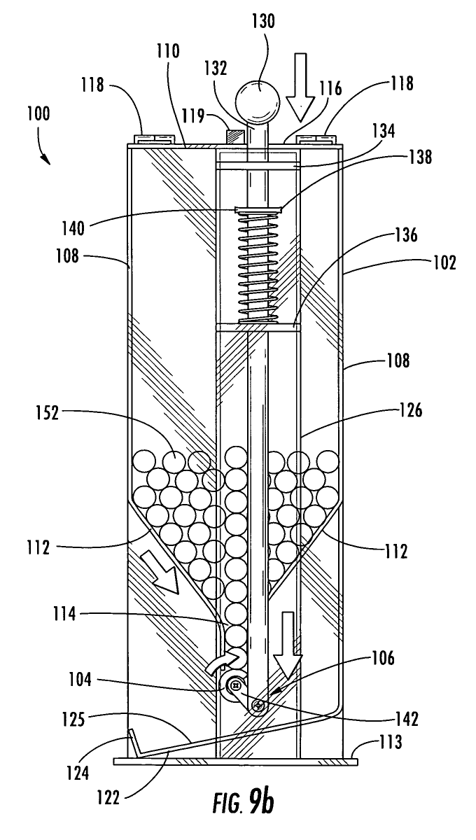

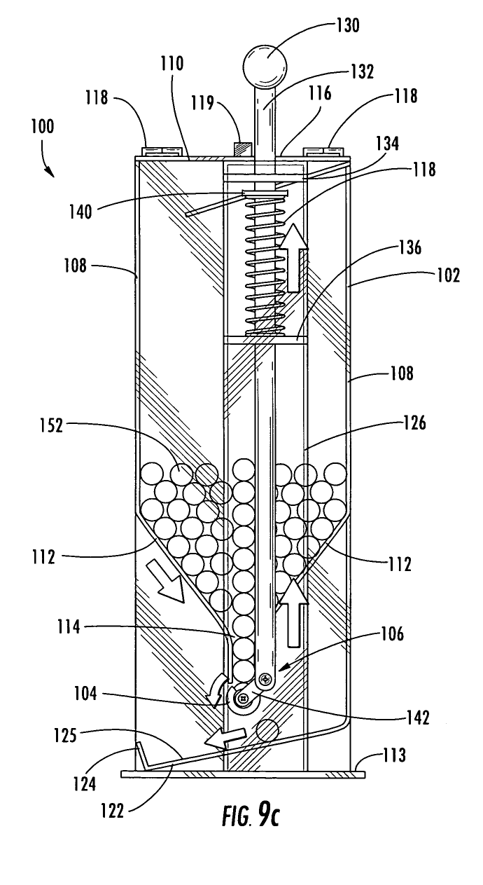

Although FIG. 9a depicts the rod 104 as receiving a single product, it is understood that the rod is capable of being configured to receive any number of products in variations of the present invention. Also, the rod could include more than one rod opening 128 for receiving respective products. For example, the chute 114 could include a pair of angled edges (similar to the angled edges 112 of the housing 102) that extends on each side of the rod 104. The rod 104 could include a pair of rod openings 128 to receive respective products from the chute 114. Alternatively, the housing 102 could include a pair of chutes 114 that extend to respective rod openings 128.

A substantial portion of the actuator 106 is disposed within an actuator housing 126. The actuator housing 126 extends from the top edge 110 of the housing 102 to the base 113. The actuator 106 includes a knob 130 attached to a longitudinal arm 132. The longitudinal arm 132 extends generally vertically through a hole in a first stop 134 and further extends through another hole in a second stop 136. A spring 138 is disposed coaxially about a portion of the longitudinal arm 132 between the first 134 and second 136 stops. A screw 140 extends through the longitudinal arm 132 and is positioned to maintain the spring 138 in a desired position and compression. As such, when the longitudinal arm 132 is urged downwardly, the screw 140 biases the spring 138 at a first end of the spring, while the second stop 136 biases the opposite end of the spring. The first stop 134 prevents the screw 140 and spring 138 from traveling upwardly beyond the first stop.

The end of the longitudinal rod 132 opposite the knob 130 is attached to a bar 142. FIG. 7 demonstrates that the bar 142 extends within a slot 144 defined in an end of the longitudinal rod 132. A first screw 146 extends through one end of the bar 142 and the slot 144. The bar 142 is capable of pivoting about the first screw 146 and within the slot 144. The opposite end of the bar 142 is attached to an extension rod 150 with a second screw 148. The extension rod 150 is coupled to the rod 104, and the housing 102 includes openings on opposite surfaces that receive opposite ends of the rod and allow the rod to pivot therein. As such, when the bar 142 is pivoted, the extension rod 150 and rod 104 cooperatively pivot. The openings in each of the first 134 and second 136 stops are of sufficient diameter to allow the longitudinal rod 132 to slide therein, as well as pivot slightly as the bar 142 is pivoted about the first 146 and second 148 screws.

According to one embodiment, for example, the housing 102 is about 15 inches in height and about 5 inches between the lateral edges 108. The depth of the lateral edges 108 is about 3 inches, while the width of the actuator housing 126 is about 2 inches (viewed from FIG. 5) and 1 inch in depth (viewed from FIG. 6). Each of the angled edges 112 are approximately 4 inches in length between the lateral edges 108 and the chute 114, and the chute is about 1 inch in length between the angled edges 112 and the rod opening 128. The rod 104 is about 3 inches in width and about 1 inch in diameter. Although specific dimensions have been described herein, it is understood that the dispensing apparatus 100 may include various sizes, orientations, and configurations that are adaptable to a variety of products.

As described above with respect to the dispensing apparatus 10, the dispensing apparatus 100 is preferably manufactured from a transparent Lucite® material, although various materials may be used. Thus, the material is typically lightweight and easy to manufacture. Each of the components of the dispensing apparatus 100 may be assembled with a suitable fastening technique, such as adhesive, fasteners, and the like.

FIGS. 9a-c illustrate the dispensing apparatus 100 filled with a plurality of products 152. In particular, as shown in FIG. 9a, the products 152 are influenced by gravity through the housing 102 and along the angled edges 112 to the chute 114. A single row of products 152 extends within the chute 114, and a single product is disposed within the rod opening 128 in a receiving position. To dispense a product, the knob 130 is pushed downwardly causing the longitudinal rod 132 to also travel downwardly. FIG. 9b demonstrates that as the longitudinal rod 132 travels downwardly, the bar 142 is forced to pivot clockwise about the first 146 and second 148 screws. The longitudinal rod 132 also experiences a slight clockwise rotation about the first 146 and second 148 screws. Pivoting the bar 142 causes the rod 104 to pivot from the receiving position to a dispensing position where a product 152 is dispensed from the rod opening 128 in the rod. The angle between the receiving position and dispensing position is approximately 90 degrees, although various angles for dispensing the products 152 may be utilized. Once dispensed from the rod 104, FIG. 9c shows that the product 152 travels down the ramp 122 and will continue until the product stops at the raised edge 124 of the dispensing tray 125. When the downward force is removed from the knob 130 and longitudinal rod 132, the spring 138 biases upwardly to cause the bar 142 to pivot counterclockwise. Thus, the spring 138 is capable of urging the bar 142 back to its original position, which also causes the rod 104 to rotate back to the receiving position where another product 152 may travel within the rod opening 128. The above steps may be repeated to dispense any number of desired products 152.

Although the above steps described with respect to FIGS. 9a-c have been described as occurring manually, it is understood that the steps could be carried out automatically in additional embodiments of the present invention. For instance, a push button could be employed to actuate the actuator 106 and automatically bias the longitudinal rod 132 to travel downwards, causing the bar 142 and rod 104 to pivot.

Furthermore, as described above with respect to the dispensing apparatus 10, the dispensing apparatus 100 is refillable and capable of displaying various advertisements. In addition, the dispensing apparatus 100 is capable of transmitting various sounds and lights for advertising and appeal.

Therefore, the present invention provides several advantages. For example, each dispensing apparatus 10 and 100 is adaptable for use with a variety of products. As such, each dispensing apparatus 10 and 100 is not limited to a particular product such that various products may be utilized using the same dispensing apparatus. In addition, each dispensing apparatus 10 and 100 is compact, which is advantageous where a limited amount of space is available, such as along check-out aisles or self-service areas. Because of the configuration and vertical orientation of each housing 12 and 102, the housing is capable of accommodating a greater amount of products than typical product dispensers. The combination of each actuator 16 and 106 and configuration of each housing 12 and 102 decreases the probability of jamming or misalignment of the products. Moreover, the self-service nature of each dispensing apparatus 10 and 100 allows a user or vendor to dispense products when desired, and each housing 12 and 102 provides increased sanitary and protection from external elements than typical dispensers. Providing a dispensing apparatus 10 and 100 that is manufactured from a clear material enables consumers to readily identify the product, while store clerks may readily determine when the apparatus requires refilling. The outer surface of the dispensing apparatus 10 and 100 is also conducive to various advertisements that may be displayed on the apparatus.

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An apparatus for dispensing products comprising:
a housing for receiving a plurality of products;
a rod pivotally coupled to the housing, the rod including at least one opening defined therein for receiving at least one of the products; and
an actuator coupled to the rod and operable to pivot the rod from a receiving position, wherein the product is positioned within the opening, to at least one dispensing position, wherein the product is dispensed from the opening.

2. The apparatus according to claim 1, wherein the housing comprises a tapered chute for funneling the products into the opening in the rod.

3. The apparatus according to claim 2, wherein the housing further comprises at least one angular divider disposed within the housing, the chute and angular divider capable of sorting and advancing each product prior to the product entering the opening in the rod.

4. The apparatus according to claim 3, wherein the housing further comprises a dispensing tray, and wherein a ramp extending proximate to the rod is capable of directing each product from the dispensing position to the dispensing tray.

5. The apparatus according to claim 1, wherein the rod extends horizontally and laterally within the housing.

6. The apparatus according to claim 1, wherein the rod comprises a pair of openings each capable of receiving a respective product and carrying the product between a receiving position and a dispensing position.

7. The apparatus according to claim 1, wherein the angle between the receiving position and the dispensing position is approximately 90 degrees.

8. The apparatus according to claim 1, wherein the actuator comprises a linkage mechanism that includes a longitudinal arm coupled to a spring and a bar.

9. The apparatus according to claim 8, wherein the rod is coupled to the bar, and wherein the longitudinal arm is operable to cooperatively rotate the bar and rod between the receiving position and the dispensing position.

10. The apparatus according to claim 8, wherein the longitudinal arm is oriented vertically, and the spring extends coaxially along a portion of the rod.

11. The apparatus according to claim 10, wherein the longitudinal arm is operable to compress the spring during cooperative rotation of the bar and rod from the receiving position to the dispensing position, and wherein the spring is operable to bias the longitudinal arm causing rotation of the bar and rod from the dispensing position to the receiving position.

12. The apparatus according to claim 1, wherein the actuator is one of manually or automatically operable.

13. The apparatus according to claim 1, wherein the actuator comprises a wheel mechanism coupled to the rod and operable to rotate the rod between the receiving position and the dispensing position.

14. The apparatus according to claim 13, wherein the rod is capable of receiving a pair of products, and wherein each product is dispensed at respective first and second dispensing positions.

15. The apparatus according to claim 13, wherein the angle between the receiving position and a first dispensing position is approximately 90 degrees, and wherein the angle between the receiving position and the second dispensing position is approximately 135 degrees.

16. The apparatus according to claim 1, wherein the products comprise at least one of chapstick, lipstick, lip gloss, lip balm, magic markers, glue sticks, batteries, laser pointers, candy holders, gum, pens, pencils, and vitamin packs.

17. A method for assembling an apparatus for dispensing products comprising:
providing an apparatus comprising:
a housing for receiving a plurality of products; and
a rod pivotally coupled to the housing, the rod including at least one opening defined therein for receiving at least one of the products; and
connecting the rod to an actuator such that the actuator is configured to pivot the rod from a receiving position, wherein the product is positioned within the opening, to at least one dispensing position, wherein the product is dispensed from the opening.

18. The method according to claim 17, wherein connecting comprises connecting the rod to the actuator such that the actuator is capable of pivoting the rod approximately 90 to 135 degrees between the receiving position and the at least one dispensing position.

19. The method according to claim 17, further comprising filling the housing with products such that one or more products are gravitationally directed to a respective opening in the rod in the receiving position.

20. The method according to claim 17, further comprising refilling the housing with products when the products have been reduced to a predetermined level.
